(19) United States
(12) Patent Application Publication
(10) Pub. No.: US 2005/0117888 A1
(43) Pub. Date: Jun. 2, 2005

(54) Video and audio reproduction apparatus

(75) Inventor: Nobuyuki Suzuki, Fuchu-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/994,535

(22) Filed: Nov. 23, 2004

(30) Foreign Application Priority Data
Nov. 28, 2003 (JP) 2003-399813

(51) Int. Cl. H04N 5/781

(52) U.S. Cl. 386/95; 386/125

(57) ABSTRACT

A stream separation unit calculates a new video PTS on the basis of a video PTS initially detected from an MPEG stream read from a recording medium in each time when a picture header is detected. The stream separation unit also calculates a new audio PTS on the basis of an audio PTS initially detected from the MPEG stream, the number of audio frames included in an audio packet of the MPEG stream, and a reproduction time of the audio frame. A video decoder and an audio decoder decode data to provide a video signal and an audio signal in accordance with each of the calculated PTSs respectively.

### CROSS-REFERENCE TO RELATED APPLICATIONS

This application is based upon and claims the benefit of priority from prior Japanese Patent Application No. 2003-399813, filed Nov. 28, 2003, the entire contents of which are incorporated herein by reference.

### BACKGROUND OF THE INVENTION

1. Field of the Invention

The present invention relates to a video and audio reproduction apparatus which reproduces an MPEG stream (MPEG-1 system stream or MPEG-2 program stream).

2. Description of the Related Art

In the MPEG stream, each of video data and audio data is packed in a pack including a predetermined amount of data. Each pack includes a pack header and a packet, each packet includes a packet header and compressed video data or audio data, and the packet header has a time stamp such as PTS (Presentation Time Stamp) or DTS (Decoding Time Stamp). The DTS is time data which shows timing for decoding data in the compressed packet, and the PTS is time data which shows the timing for displaying the decoded data. The compressed data in the packet is decoded at the timing shown by the DTS and displayed at the timing shown by the PTS. DVD Specification for Read-Only Disk/part 3, Video Specification provides an explanation of the standard with respect to DTS and PTS and the reproduction of the MPEG stream utilizing DTS and PTS.

In a disk, particularly a disk such as a video CD in which authoring is performed by a personal user (or an authoring system of a third party), reliability is low in the time stamp. In a disk in which the MPEG stream is recorded, when an error is present in the time stamp recorded in the disk, synchronous reproduction of the video image and the sound is not correctly performed. For example, the video image and the sound are reproduced while the video image and the sound are shifted from each other.

### BRIEF SUMMARY OF THE INVENTION

According to one embodiment of the invention, there is provided a video and audio reproduction apparatus for reproducing an MPEG stream including each of video and audio elementary streams recorded in a medium, the apparatus comprising: a read unit which reads the MPEG stream from the medium; a first acquisition unit which acquires a video PTS (Presentation Time Stamp) from the MPEG stream read by the read unit; a first calculation unit which calculates a new video PTS on the basis of the PTS acquired by the first acquired unit in each time when a picture header is detected from the read MPEG stream; a second acquisition unit which acquires an audio PTS from the read MPEG stream; a second calculation unit which counts the number of audio frames included in an audio packet of the read MPEG stream and calculates a new audio PTS on the basis of the PTS acquired by the second acquired unit and a reproduction time of the audio frame; a video decoder which decodes video data of the read MPEG stream to provide a video signal in accordance with the PTS calculated by the first calculation unit; and an audio decoder which decodes audio data of the MPEG stream read by the second calculation unit to provide an audio signal in accordance with the PTS calculated by the second calculation unit.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram during reproduction of a DVD video apparatus of the invention;

FIG. 2 shows a structure of an MPEG system stream;

FIG. 3 is a processing flowchart of a stream separation unit;

FIGS. 4A to 4C show details of a flag and a register of the stream separation unit;

FIG. 5 shows a layer structure of the MPEG system stream;

FIG. 6 shows a structure of a video sector of a video CD;

FIG. 7 shows a structure of an audio sector of the video CD;

FIG. 8 shows contents of a packet header;

FIG. 9 shows contents of a packet header of a video packet;

FIG. 10 shows contents of the packet header of an audio packet;

FIG. 11 is a processing flowchart of “Video Pack Processing” of the stream separation unit;

FIG. 12 is a processing flowchart of “Audio Pack Processing” of the stream separation unit;

FIG. 13 is a processing flowchart of “Video Packet Processing” of the stream separation unit;

FIG. 14 is a processing flowchart of “Audio Packet Processing” of the stream separation unit;

FIG. 15 is a processing flowchart of “Video Data Processing” of the stream separation unit;

FIG. 16 shows a flag in sequence_header of MPEG video;

FIG. 17 is a processing flowchart of “Video Data Initial Processing” of the stream separation unit;

FIG. 18 shows a flag in picture_header of MPEG video;

FIG. 19 shows a relationship of a video time stamp;

FIG. 20 shows an overview of audio time stamp calculation;

FIG. 21 is a processing flowchart of “sequence_header Analysis” of the stream separation unit;

FIG. 22 is a processing flowchart of “Video Data Normal Processing” of the stream separation unit;

FIG. 23 is a processing flowchart of “Audio Data Processing” of the stream separation unit;

FIG. 24 is a processing flowchart of “Audio PTS Calculation” of the stream separation unit;

FIG. 25 shows a flag in a header of an audio frame of MPEG-1 audio;

FIG. 26 is a table of bit_rate_index of MPEG-1 audio;

FIG. 27 is a processing flowchart of “Audio PTS Correction Processing” of the stream separation unit;

FIG. 28 shows a track structure of a video CD; and

FIG. 29 shows contents of a system header of the video CD.

### DETAILED DESCRIPTION OF THE INVENTION

Referring now to the accompanying drawings, preferred embodiments of the invention will be described in detail.

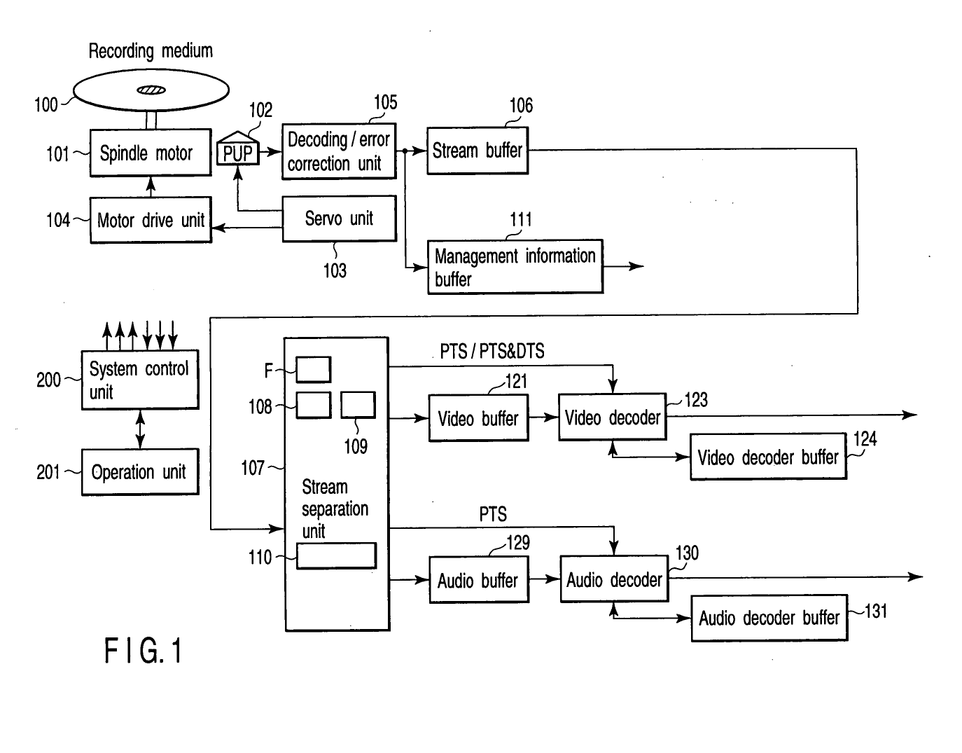

FIG. 1 is a block diagram showing a configuration of an audio and video reproduction apparatus according to an embodiment of the invention.

A recording medium 100 loaded on a turntable (not shown) is rotated by a spindle motor 101. A servo unit 103 performs feed control in a disk radial direction, focus control, and tracking control of a pickup unit 102. During the reproduction, information recorded in the recording medium 100 is read by the pickup unit 102. The servo unit 103 also transmits a control signal to a motor drive unit 104 to perform rotational control of the spindle motor 101, i.e. the rotational control of the recording medium 100.

Output of the pickup unit 102 is inputted to a demodulating/error correction unit 105 to perform demodulation and error correction. The error corrected data is inputted to a stream separation unit 107 through a stream buffer 106. The error corrected data is transmitted to a system control unit 200 through a management information buffer 111. Management information such as TOC (Table Of Contents) information is written in the management information buffer 111, and the system control unit 200 reads the management information to perform reproduction control. The stream separation unit 107 performs a process of separating each pack. A video pack (V_PCK) fetched from the stream separation unit 107 is inputted to a video decoder 123 through a video buffer 121 and decoded by the video decoder 123. The video decoder 123 is connected to a video decoder buffer 124. A video signal outputted from the video decoder 123 is supplied to a display. An audio pack (A_PCK) fetched from the stream separation unit 107 is inputted to an audio decoder 130 through an audio buffer 129 and decoded by the audio decoder 130. The audio decoder 130 is connected to an audio decoder buffer 131. A/D conversion (not shown) of the output of the audio decoder 130 is performed and supplied to a speaker. Thus, the recording medium 100 includes video information and audio information, and the video information and the audio information are separated and derived in the stream separation unit 107.

User's operation input is given to the system control unit 200 through an operation unit 201. Decoding processing corresponding to a type of display device is performed in the video decoder 123 which decodes video information. For example, the video information is converted into NTSC, PAL, or the like. Audio information of a stream specified by a user is inputted to and decoded by the audio decoder 130.

The operation of the stream separation unit 107 will schematically be described below.

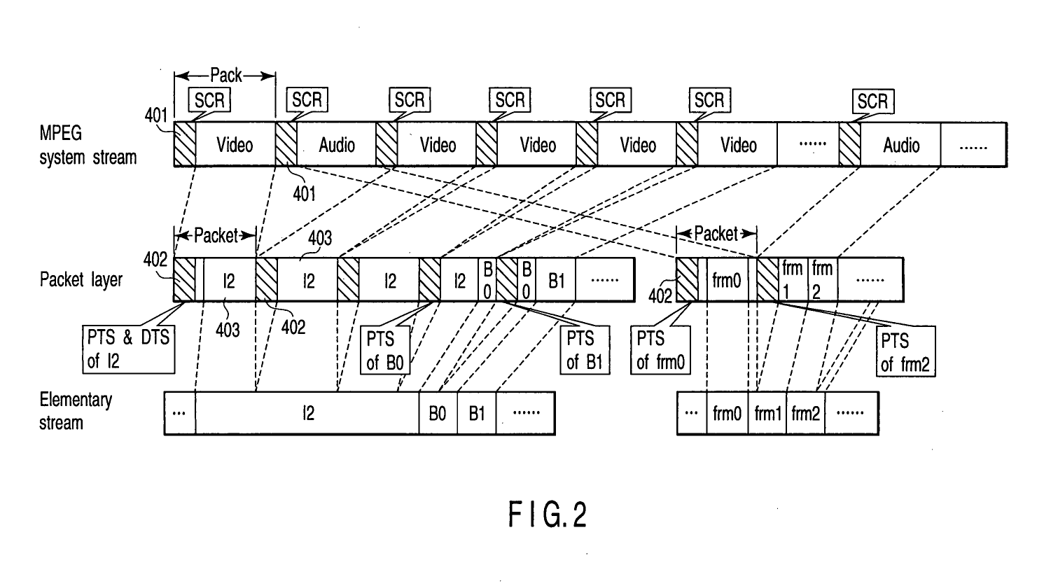

FIG. 2 shows a structure of an MPEG system stream (MPEG-2 program stream or MPEG-1 system stream).

It is assumed that the PMEG stream includes a video pack and an audio pack. Information SCR (System Clock Reference) on a time when a pack reaches an input buffer (the video buffer 121 and the audio buffer 129 in FIG. 1) of each elementary decoder is described in a pack header 401. Each pack may have at least one packet. A payload (a part except a packet header 402) 403 of the packet can have only single piece of elementary data. For example, the video data and the audio data can not be mixed together as one payload of the packet. In the packet header 402 of each packet, stream_id is described.

When a leading edge of picture data is included in the packet, a time DTS in which the picture data is decoded for a picture which includes the leading edge or a time PTS in which the picture data is displayed for the picture which includes the leading edge can be described in the packet header 402 of the video packet. When the picture is an I picture or a P picture, DTS and PTS can be described in the packet header 402. When the picture is a B picture, only PTS can be described in the packet header 402.

When the leading edge of an audio frame is included in the packet, a time PTS in which the audio data is decoded and displayed for the audio frame which includes the leading edge can be described in the packet header 402 of the audio packet.

When the stream separation unit 107 detects a packet having a value of the same stream_id as stream_id set from the system control unit 200, the stream separation unit 107 separates and inputs the payload of the packet to the input buffer (the video buffer 121 and the audio buffer 129 in FIG. 1) of the corresponding elementary decoder. The stream separation unit 107 resets all system time clocks STC in the system with the SCR of the pack during system startup and transmits the PTS and DTS separated from the packet of each elementary stream to each elementary decoder (the video decoder 123 and the audio decoder 130 in FIG. 2). Each elementary decoder compares the time (STC) owned by each elementary decoder to the PTS and DTS received from the stream separation unit 107 to perform the decoding or the display when the time, for example, coincides with the PTS and DTS.

The process of updating the time stamp performed by the stream separation unit 107 according to the embodiment of the invention will be described below. In FIG. 1, it is assumed that the recording medium 100 id a video CD. A stream of the video CD complies with an MPEG-1 System Stream (ISO/IEC 11172-2), video data complies with MPEG-1 Video (ISO/IEC 11172-2), and audio data complies with Layer-II of MPEG-1 Audio (ISO/IEC 11172-3), respectively.

The time stamp (PTS/DTS) is generally generated based on a clock of 90 kHz. Namely, one unit of the time stamp corresponds to 1/90000 second. In the video CD, one sector includes one pack and data transfer rate of the disk is 75 sector/sec. Therefore, a difference ΔSCR in SCR between the continuous packs is always ΔSCR=90000/75=1200 (unit: 90 kHz).

When the system control unit 200 starts up (or restarts) the system, the system control unit 200 transmits a stop command to the demodulating/error correction unit 105, the stream separation unit 107, the video decoder 123, and the audio decoder 130. When the system control unit 200 confirms that the demodulating/error correction unit 105, the stream separation unit 107, the video decoder 123, and the audio decoder 130 are stopped, the system control unit 200 clears the stream buffer 106, the video buffer 121, and the audio buffer 129. When the system control unit 200 confirms that each buffer is cleared, the system control unit 200 transmits a startup command to the demodulating/error correction unit 105, the stream separation unit 107, the video decoder 123, and the audio decoder 130 to newly set a capture address of the recording medium 100 in the servo unit 103.

The servo unit 103 controls the pickup unit 102. The output of the pickup unit 102 is demodulated and error corrected by the demodulating/error correction unit 105 and inputted to the stream buffer 106. In order to avoid underflow of the stream buffer 106, the stream separation unit 107 starts reading sector data after a certain amount of data is stored in the stream buffer 106, and the stream separation unit 107 temporarily holds the sector data in an internal buffer of the stream separation unit 107. The held sector data is classified into video sector data, audio sector data, empty sector data, and the like to perform the processing to respective piece of sector data by analyzing a sub-header thereof.

After the startup, the stream separation unit 107 holds the initially detected I-picture DTS and PTS and the initially detected audio PTS. Then, the stream separation unit 107 calculates the video and audio time stamps without using the video and audio time stamps (PTS/DTS) described in the stream, and performs the STC control by transmitting the calculated values of the video and audio time stamps to the video decoder 123 and the audio decoder 130.

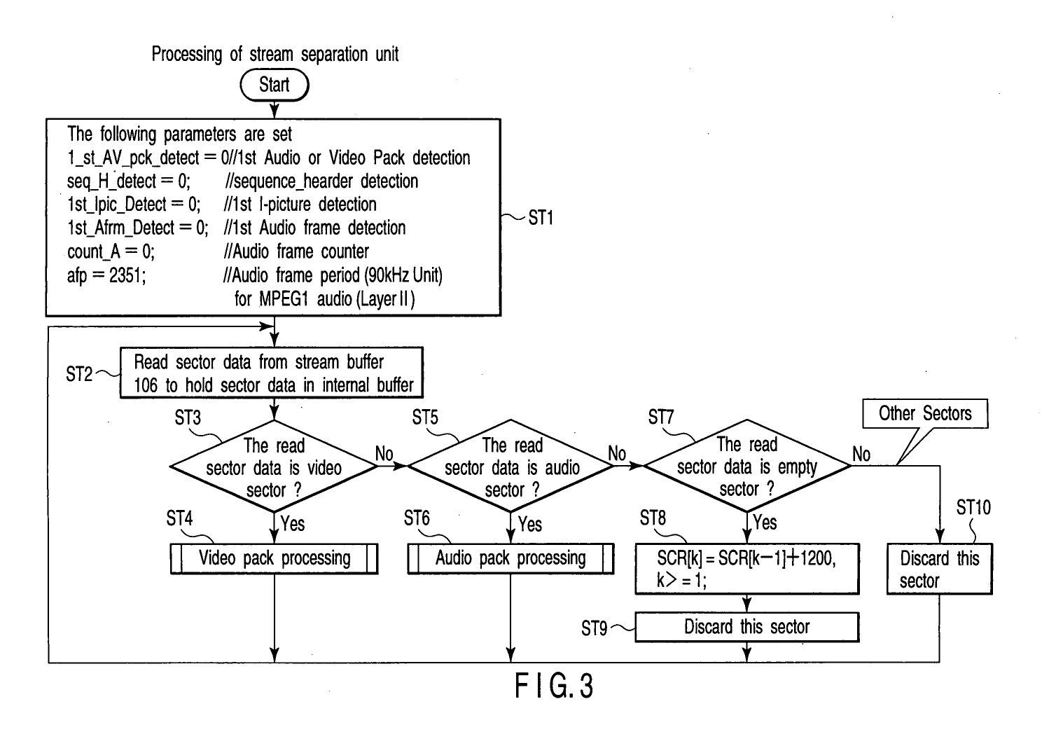

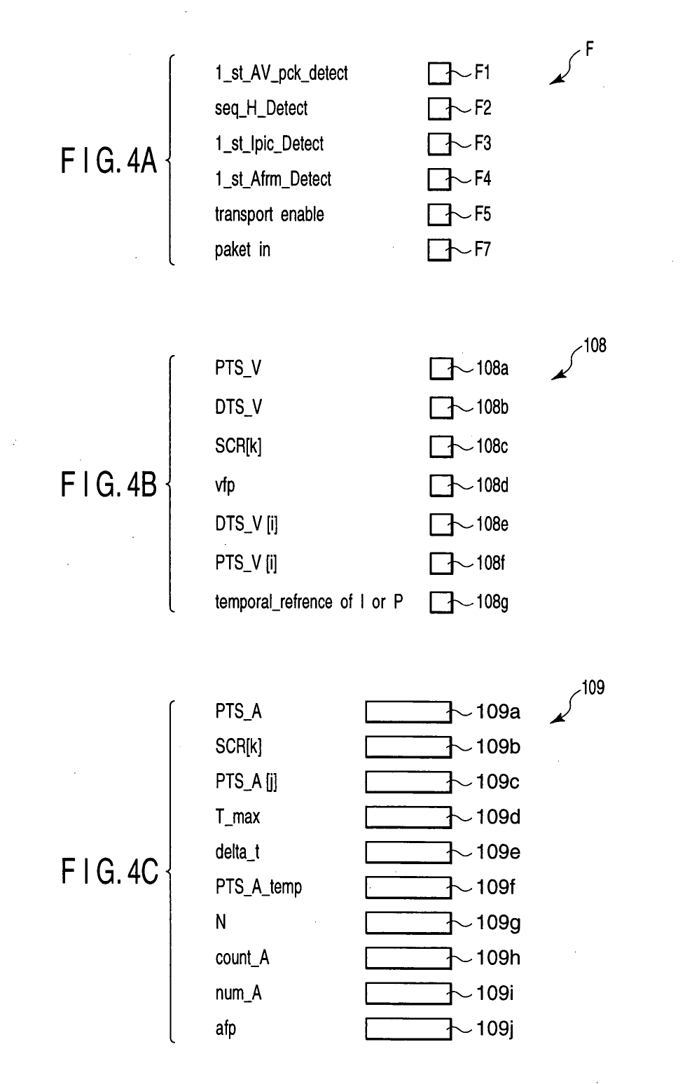

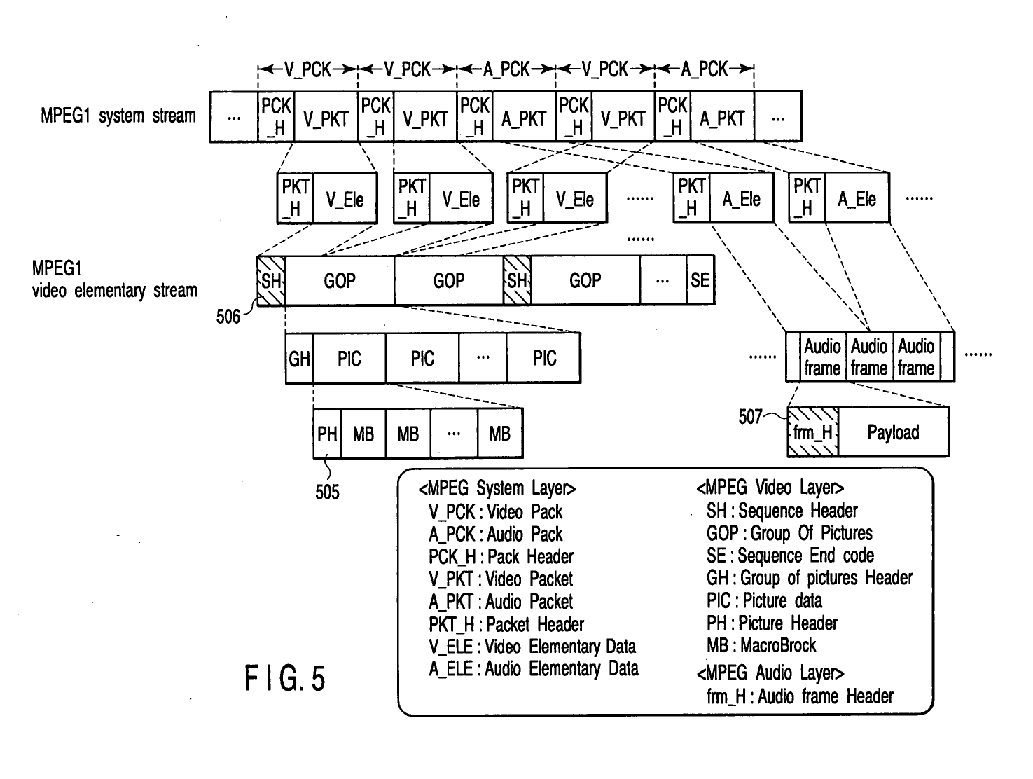

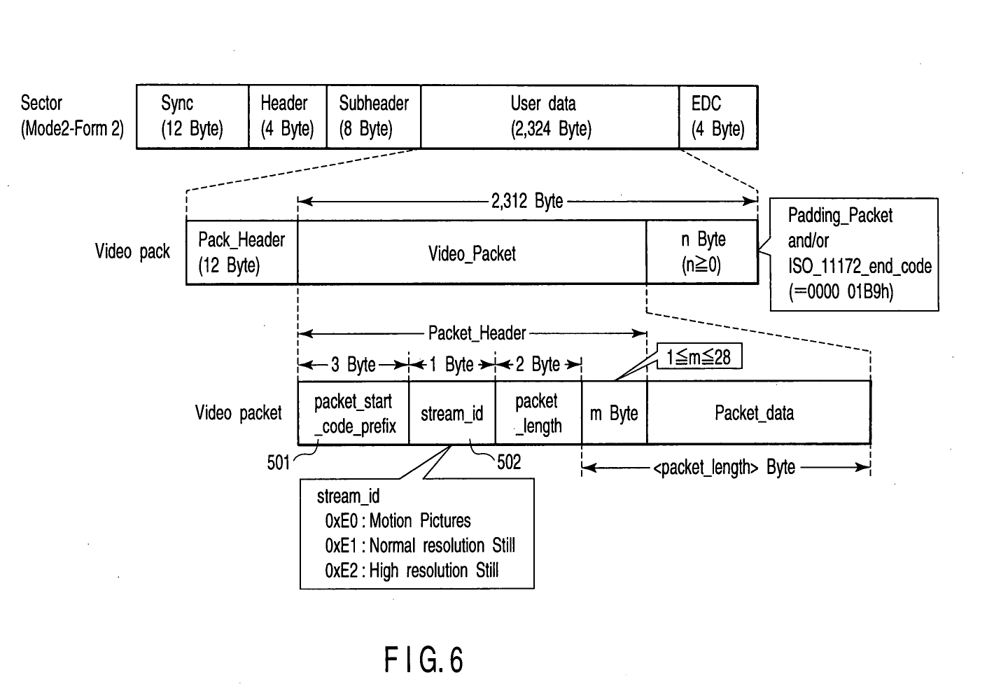

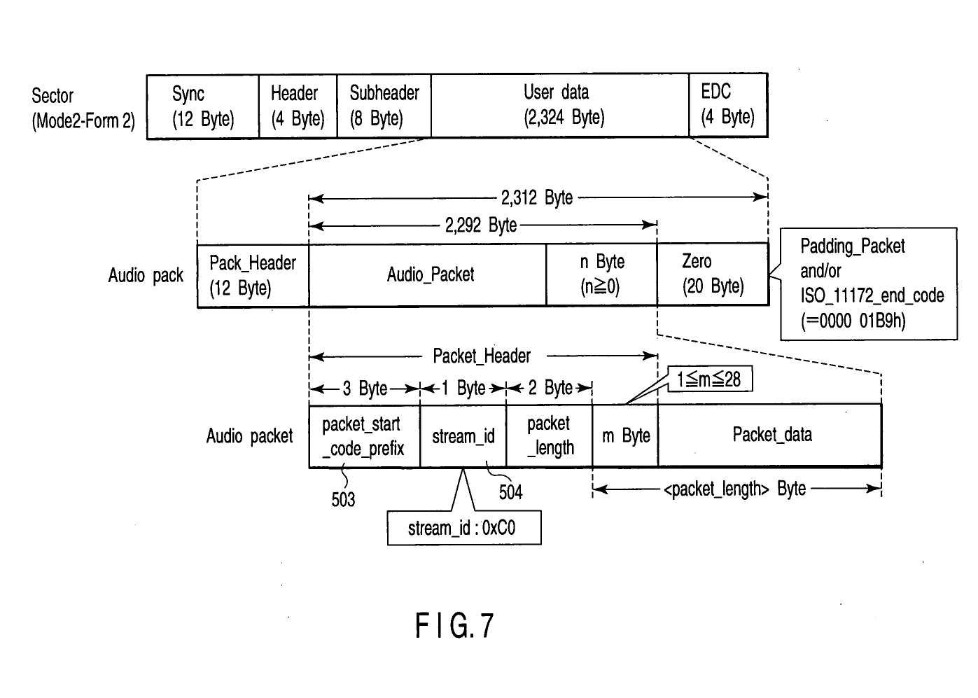

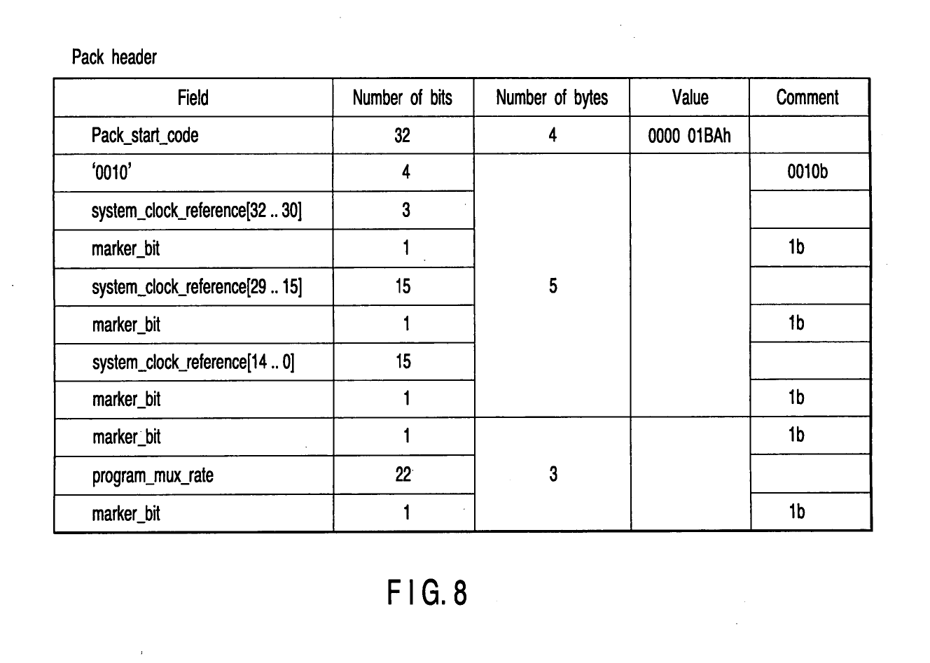

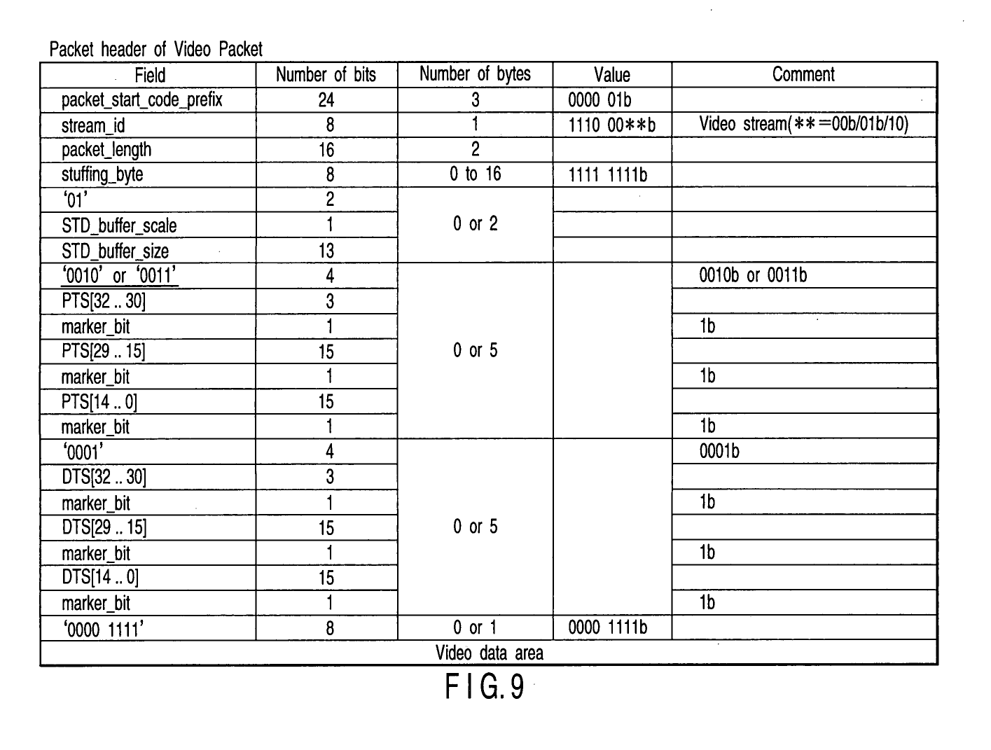

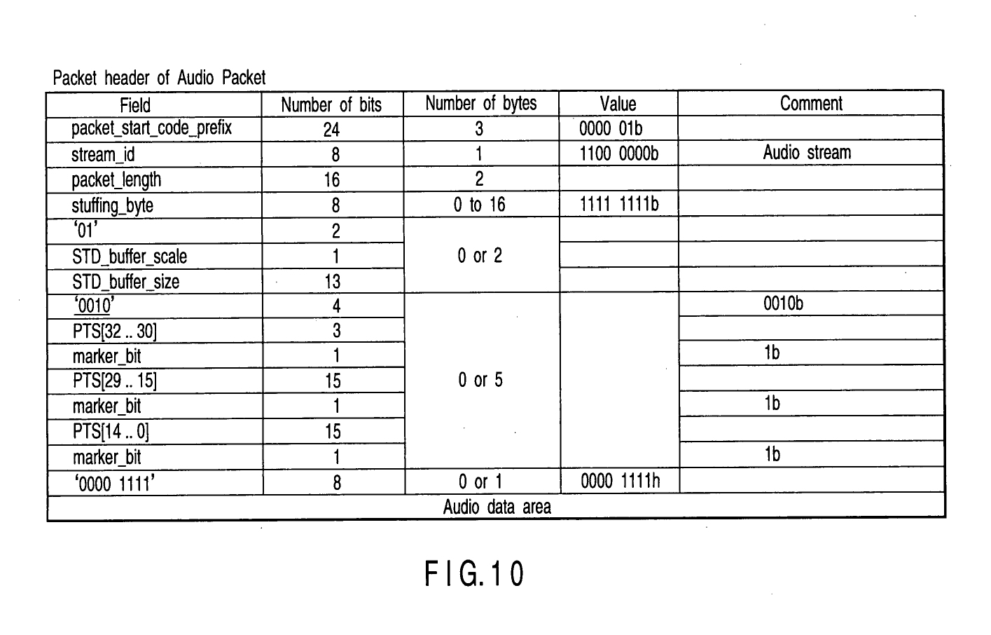

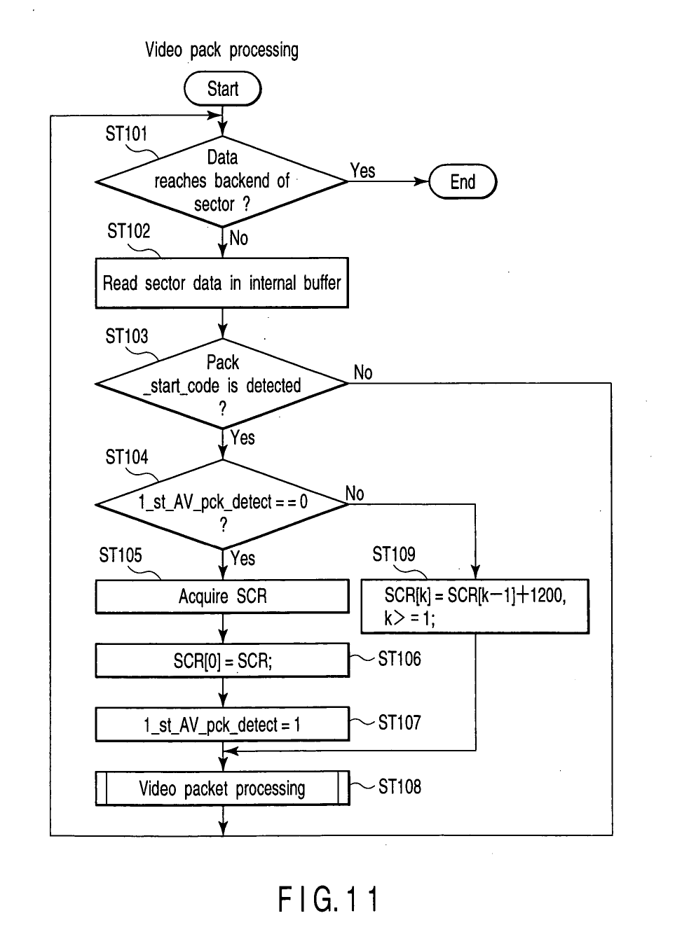

The process of calculating the time stamp (PTS/DTS) performed by the stream separation unit 107 will be described below. FIG. 3 is a flowchart schematically showing the process by the stream separation unit 107, FIG. 4 shows details of a flag and a register of the stream separation unit 107, FIG. 5 shows a layer structure of the MPEG system stream, FIG. 6 shows the structure of the video sector of the video CD, FIG. 7 shows the structure of the audio sector of the video CD, FIG. 8 shows contents of the pack header, FIG. 9 shows contents of the packet header of the video packet, and FIG. 10 shows contents of the packet header of the audio packet.

The stream separation unit 107 has flags F1 to F7 shown in FIG. 4A, registers 108a to 108g shown in FIG. 4B concerning the video, and registers 109a to 109j shown in FIG. 4C concerning the audio. As shown in Step ST001 of FIG. 3, the stream separation unit 107 first sets a parameter (flag and register). Namely, the stream separation unit 107 sets the flag F1 of 1st_AV_pck_detect, the flag F2 of seq_H_detect, the flag F3 of 1st_Ipic_Detect, the flag F4 of 1st_Afrm_Detect, and the flag F5 of count_A to zero and writes 2351 in the register 109i of afp.

In Step ST002, the stream separation unit 107 reads the sector data from the stream buffer 106 to hold the stream data in the internal buffer 110. Then, the stream separation unit 107 determines the type of sector data. As shown in the layer structure of the MPEG system stream of FIG. 5, when the read sector data is the video sector (V_PCK) (YES in ST003), the stream separation unit 107 performs a video pack processing (ST004).

FIG. 11 is a flowchart showing a video pack processing.

The stream separation unit 107 determines whether or not a position of the data read in the sector reaches a backend of the sector (Step ST101). When the read data does not reach the backend of the sector, the stream separation unit 107 further reads contents of the sector data internal buffer 110 (ST102). In Step ST103, the stream separation unit 107 determines whether or not pack_start_code (see FIG. 8) of the pack header 401 is detected. When pack_start_code is detected, as shown in Step ST104, the stream separation unit 107 determines whether or not the flag F1 of 1st_AV_pck_detect is zero. When the flag F1 is zero, the stream separation unit 107 acquires an SCR from the pack header 401 (ST105) to write the value of the SCR in the register 108c as the value of SCR[0] (ST106). Then, the stream separation unit 107 sets the flag F1 of1st_AV_pck_detect to 1 (ST107). When the flag F1 is not zero, i.e. when the read video pack is the second or subsequent video pack, the stream separation unit 107 writes the value in which 1200 is added to the previous SCR value SCR[k-1] in the register 108c of SCR. 1200 is a difference between the SCR values of the adjacent packs, and the difference is always constant. Then, the stream separation unit 107 performs a video pack processing (ST108).

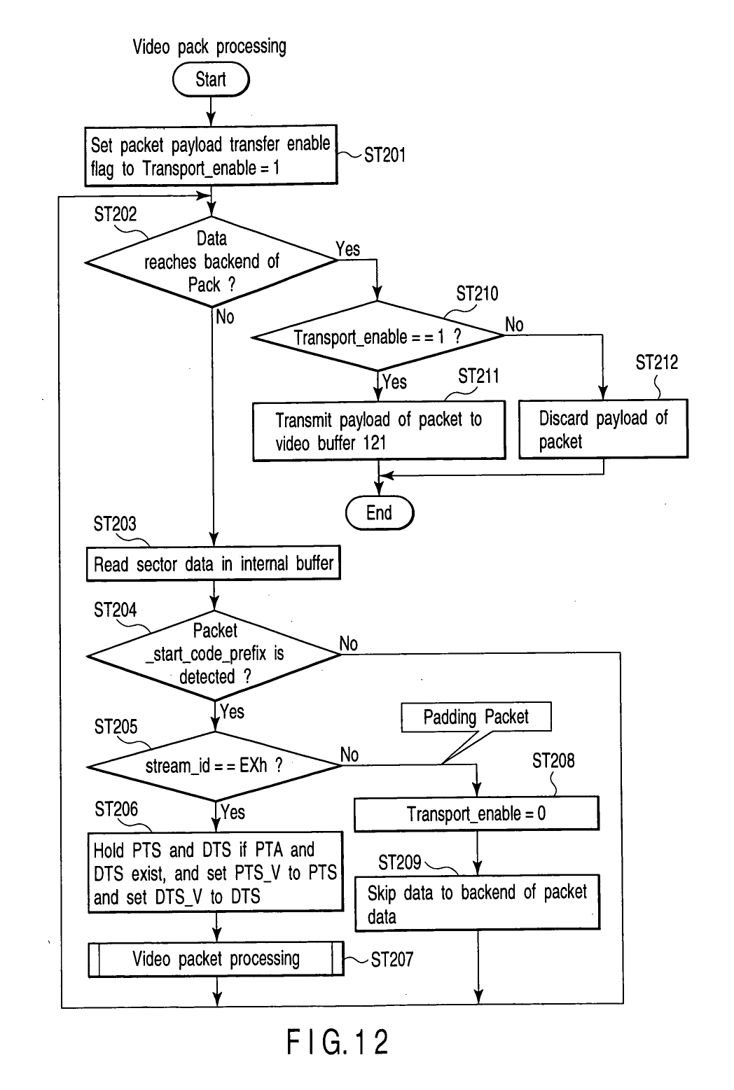

FIG. 12 is a flow chart showing the video pack processing.

The stream separation unit 107 sets the packet payload transfer enable flag F5 to 1 (Step ST201), and determines whether or not the position of the data reaches the backend of the pack (Step ST202). When the position of the data does not reach the backend of the pack, the stream separation unit 107 reads predetermined bytes of the contents of the sector data internal buffer 110 (ST203). Then, the stream separation unit 107 determines whether or not packet_start_code_prefix 501 (see FIGS. 6 and 9) is detected (ST204). When packet_start_code_prefix 501 is detected, the stream separation unit 107 determines whether or not stream_id 502 (see FIGS. 6 and 9) is EXh (ST205). “EXh” is stream_id of the video which is set in the stream separation unit 107 by the system control unit 200, and shows one of a motion picture, a normal resolution still, and a high resolution still. In the case where stream_id is EXh, the stream separation unit 107 holds PTS and DTS when PTS and DTS exist, and the stream separation unit 107 writes the value of the PTS in the register 108a of PTS_V and writes the value of the DTS in the register 108b of DTS_V (ST206). Then, the stream separation unit 107 proceeds to a. video data processing (ST207).

When stream_id is not EXh in Step ST205, the stream separation unit 107 determines that the packet which is currently being read is a padding packet and sets the transfer enable flag F5 to zero (ST208). Therefore, the stream separation unit 107 prohibits the packet data from being transferred to the video buffer 121 and skips the packet data to the backend of the packet data (ST209).

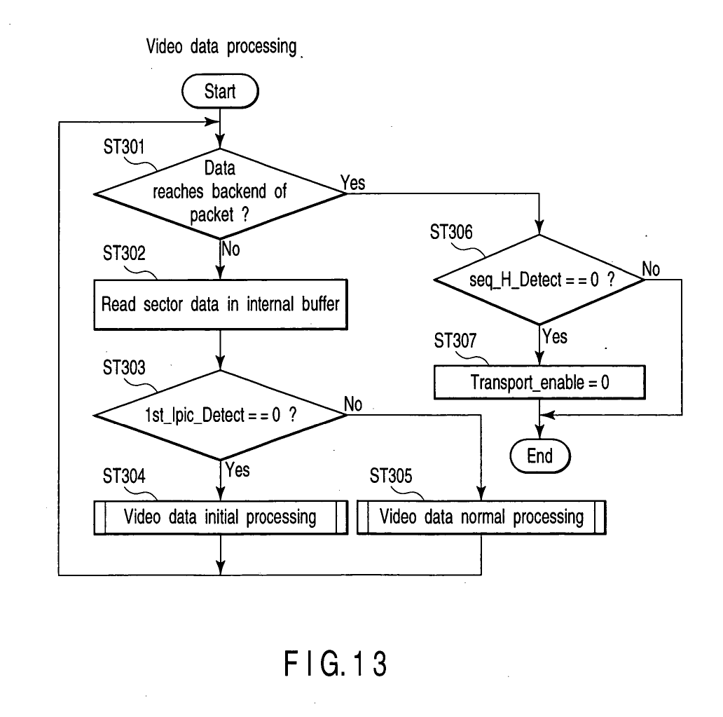

FIG. 13 is a flowchart showing the video data processing.

The stream separation unit 107 determines whether or not the position of the data reaches the backend of the sector (Step ST301). When the position of the data does not reach the backend of the sector, the stream separation unit 107 reads predetermined bytes of the contents of the sector data internal buffer 110 (ST302). In Step ST303, the stream separation unit 107 determines whether or not the flag F3 of 1st_Ipic_Detect is zero. When the flag F3 is zero, the stream separation unit 107 performs a video data initial processing (ST304).

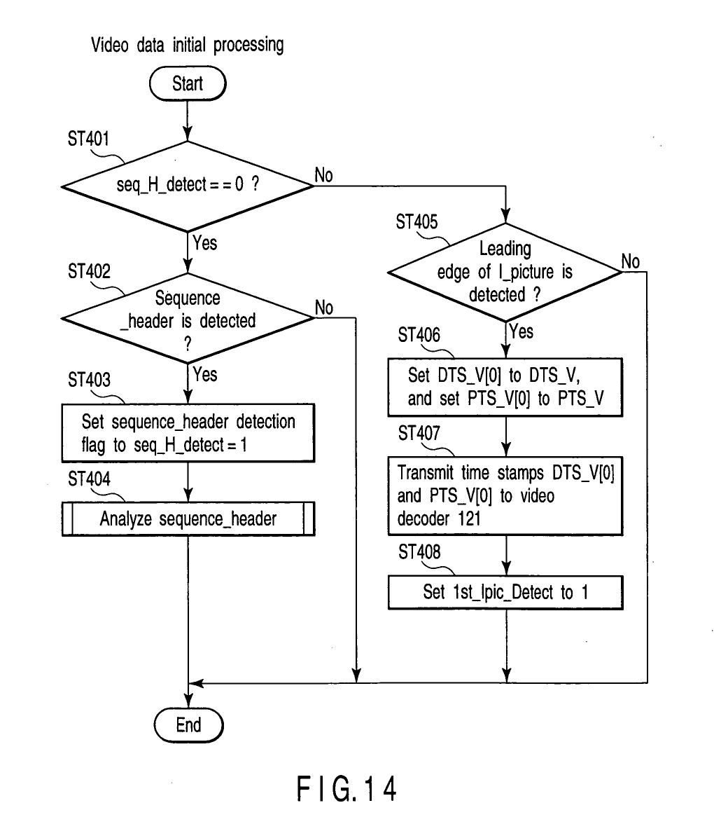

FIG. 14 is a flowchart showing the video data initial processing.

The stream separation unit 107 determines whether or not the flag F2 of seq_H_detect is zero. When the flag F2 is zero, the stream separation unit 107 detects a sequence header 506 (see FIG. 5) (ST402), sets the sequence header detection (seq_H_detect) flag F2 to 1 (ST403), and analyzes the sequence header 506 (ST404).

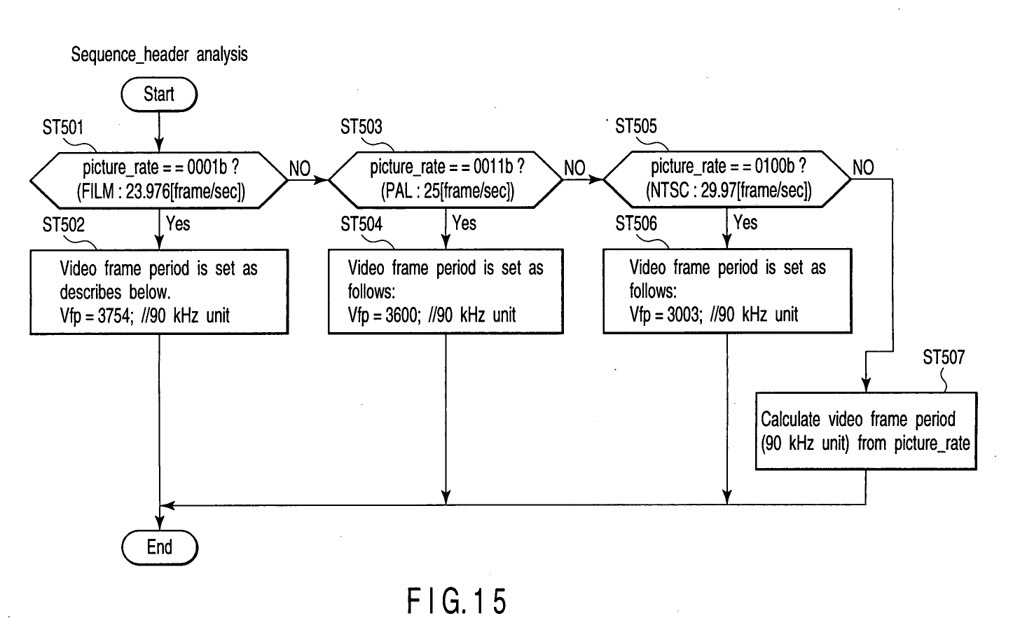

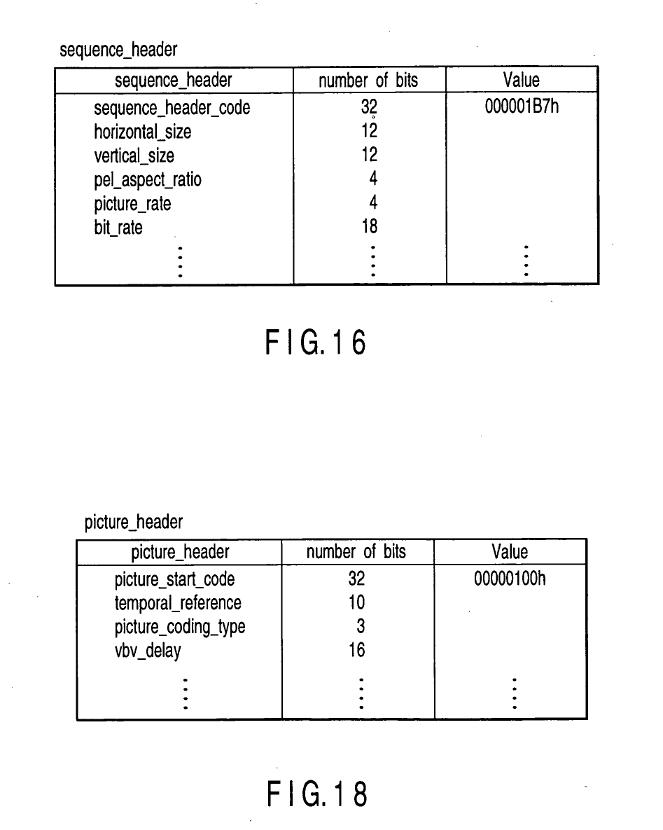

FIG. 15 is a flowchart showing analysis of the sequence header, and FIG. 16 shows the flag in sequence_header of the MPEG video.

The stream separation unit 107 determines whether or not picture_rate (see FIG. 16) is 0001b, i.e. whether or not the read video is FILM Standard (Step ST501). When the video is FILM Standard, the stream separation unit 107 writes 3754 in the register 108d of vfp (video frame period) (ST502). 3754 shows the time of continuous 3754 clocks at 90 kHz.

When the video is not FILM Standard, the stream separation unit 107 determines whether or not picture_rate is 0011b, i.e. whether or not the read video is PAL Standard (ST503). When the video is PAL Standard, the stream separation unit 107 writes 3754 in the register 108d of vfr (ST504).

When the video is not PAL Standard in Step ST503, the stream separation unit 107 determines whether or not picture_rate is 0100b, i.e. whether or not the read video is NTSC Standard (ST505). When the video is NTSC Standard, the stream separation unit 107 writes 3003 in the register 108d of vfr (ST506).

When the video is not NTSC Standard in Step ST505, the stream separation unit 107 calculates the video frame period vfp based on picture_rate (ST509).

Now returning to the description of FIG. 14, when the flag F2 is not zero, the stream separation unit 107 determines whether or not the leading edge of I_picture is detected (ST405). When the leading edge of I_picture is detected, the stream separation unit 107 writes the value of the register 108b of DTS_V, which has been written in ST206, as the value of the zeroth DTS_V in the register 108e of DTS_V[i], and the stream separation unit 107 writes the value of the register 108a as the value of the zeroth PTS_V in the register 108f of PTS_V[i] (ST406).

The stream separation unit 107 transmits the values of the time stamps PTS_V[0] and PTS_V[0] of the picture to the video decoder 123 (ST407), and sets the flag F3 of 1st_Ipic_Detect to 1 (ST408).

Returning to FIG. 13, when the flag F3 is not zero in Step ST303, i.e. when the first I picture is already detected, the stream separation unit 107 performs a video data normal processing (ST305).

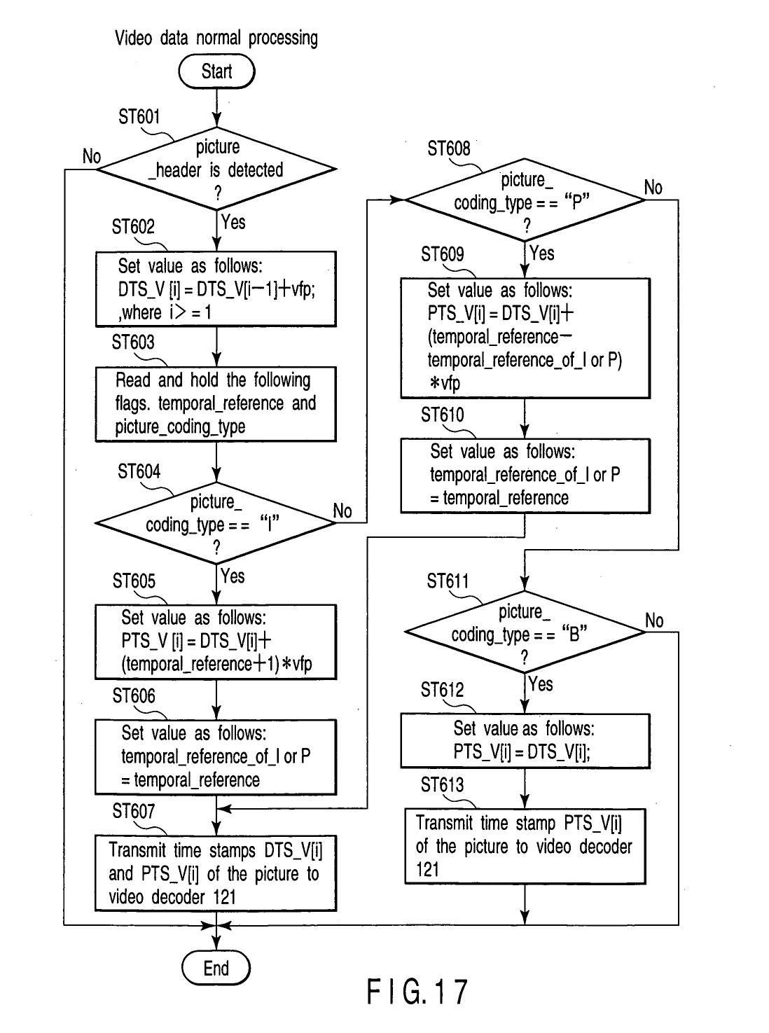

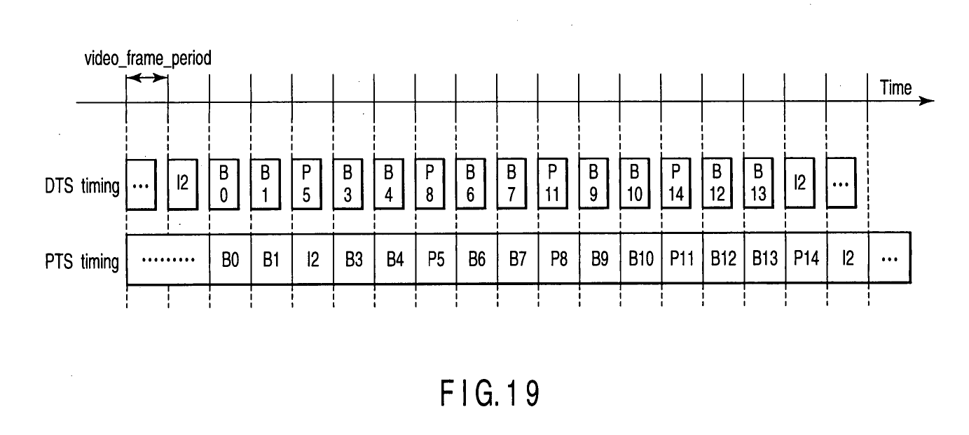

FIG. 17 is a flowchart of the video data normal processing, FIG. 18 shows the flag in picture_header of the MPEG video, and FIG. 19 shows a relationship of the time stamp of the video.

The stream separation unit 107 determines whether or not the picture_header 505 (see FIG. 5) is detected (ST601). When the picture_header 505 (see FIG. 5) is detected, the stream separation unit 107 writes the value in which the video frame period (vfp) is added to the previous value DTS_V[i-1] in the register 108e of DTS_V[i] (ST602). In Step ST603, the stream separation unit 107 reads the flags of temporal_reference and picture_coding_type (see FIG. 18). When picture_coding_type is “I,” i.e. the I picture (ST604), the stream separation unit 107 writes the value to which (temporal_reference+1)×vfp is added in the value of DTS_V[i]. The temporal_reference shows the order of display of each picture in GOP (Group Of Pictures). For example, in FIG. 19, temporal_reference shows “2” in I2 or “0” in B0. As shown in FIG. 19, since the recording order differs from the display order in the I picture, the processing shown in Step ST605 is required.

The stream separation unit 107 writes the value of temporal_reference in the register 108g of temporal_reference_of_I or P (ST606), and transmits the values of registers 108e and 108f as the time stamps DTS_V[i] and PTS_V[i] of the picture (ST607). The processes (ST608 to ST610) of the P picture are performed in the same way as the I picture. In the case of the P picture, because the order of temporal_reference is similar to the display order, the stream separation unit 107 writes the value of the register 108e of DTS_[i] in the register of PTS_V[i], and the stream separation unit 107 transmits the value of the register 108e as the time stamp PTS_V[i] of the picture to the video decoder 123.

Thus, in each time when the stream separation unit 107 detects the picture header from the MPEG stream read, the stream separation unit 107 calculates the new PTS of the video on the basis of PTS initially acquired in Step ST406 and picture_coding_type and temporal_reference described in the picture header.

Returning to FIG. 13, when the position of the data read reaches the backend of the sector in Step ST301, the stream separation unit 107 determines whether or not the flag F2 of seq_H_Detect is zero (ST306). When the flag F2 is not zero, the stream separation unit 107 transfers the process to Step ST210 of FIG. 12. When the flag F2 is zero, the stream separation unit 107 sets the flag F6 of transport_enable to zero (the stream separation unit 107 prohibits the payload from being transferred to the video buffer 121) and transfers the process to Step ST210.

In Step ST210 of FIG. 12, the stream separation unit 107 determines whether or not the flag F6 of transport_enable is 1 (whether or not the flag F6 can be transported). When the flag F6 can not be transported, the stream separation unit 107 discards the payload of the packet (ST212). When the flag F6 can be transported, the stream separation unit 107 transfers the payload of the packet to the video buffer 121 (ST211).

Returning to FIG. 3, when the read sector data is the audio sector (A_PCK) (YES in ST005), the stream separation unit 107 performs an audio pack processing (ST006).

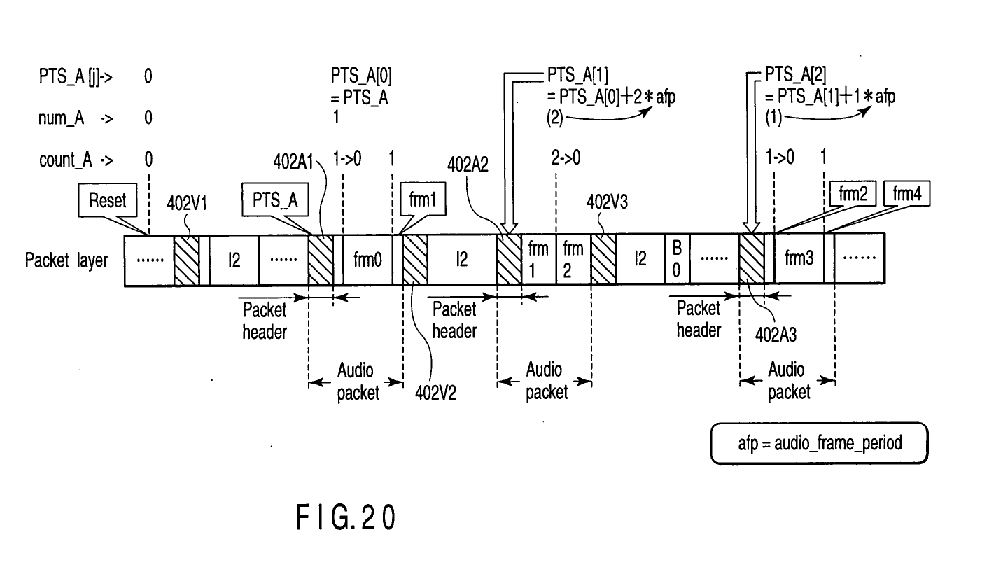

FIG. 20 shows an overview of the audio time stamp calculation.

In FIG. 20, reference numerals 402A1 to 402A3 represent the audio packet header and reference numerals 402V1 to 402V3 represent the video packet header. The audio packet of the packet header 402A1 includes audio frames frm0 and frm1, the audio packet of the packet header 402A2 includes audio frames frm1 and frm2, and the audio packet of the packet header 402A3 includes audio frames frm2, frm3, and frm4. PTS for the audio frame frm0 is recorded in the packet header 402A1, PTS for the audio frame frm2 is recorded in the packet header 402A2, and PTS for the audio frame frm3 is recorded in the packet header 402A3. At this point, it is assumed that PT_A is described as PTS of the packet header 402A1.

A parameter count_A is the value in which the number of audio frames is counted. The parameter count_A is reset when the leading edge of the audio frame detected subsequent to the audio packet header is detected. For example, the parameter count_A is reset at the leading edge of the audio frame frm0, the leading edge of the audio frame frm2, and the leading edge of the audio frame frm3. A parameter num_A holds the value immediately before the parameter count_A is reset. Therefore, the parameter num_A shows the number of audio frames which exist in the range from the leading edge of the audio frame subsequent to a certain audio packet (for example, the leading edge of frm0) to the leading edge of the audio frame subsequent to the next audio packet (for example, the leading edge of frm2).

PTS_A[j] is obtained by adding the previous PTS_A[j-1] and num_A*afp. At this point, afp is a reproduction time of the audio frame. For example, PTS_A[1] is PTS_A[0]+2*afp in FIG. 20.

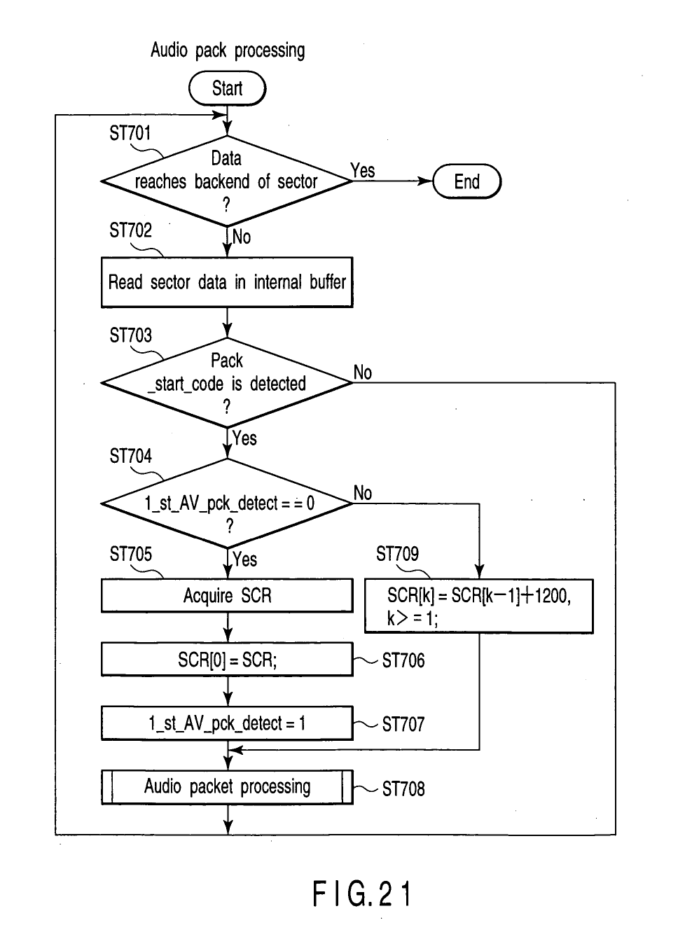

FIG. 21 is a flowchart showing the audio pack processing. The audio pack processing is similar to the video pack processing of FIG. 11.

The stream separation unit 107 determines whether or not the position of the read data reaches the backend of the sector (ST701). When the position of the read data does not reach the backend of the sector, the stream separation unit 107 further reads the contents of the sector data internal buffer 110 (ST702). In Step ST703, the stream separation unit 107 determines whether or not pack_start_code (see FIG. 8) of the pack header 401 is detected. When pack_start_code is detected, in Step ST704, the stream separation unit 107 determines whether or not the flag F1 of1st_AV_pck_detect is zero. When the flag F is zero, the stream separation unit 107 acquires an SCR from the pack header 401 (ST705), the stream separation unit 107 writes the value of the SCR in the register 109b of SCR[k] (ST706), and sets the flag F1 of 1st_AV_pck_detect to 1 (ST707). When the flag F1 of 1st_AV_pck_detect is not zero, i.e. when the read audio pack is the second or subsequent audio pack, the stream separation unit 107 writes the value, in which 1200 is added to the previous SCR value SCR[k-1], in the register 109b of SCR. Then, the stream separation unit 107 performs an audio packet processing (ST708).

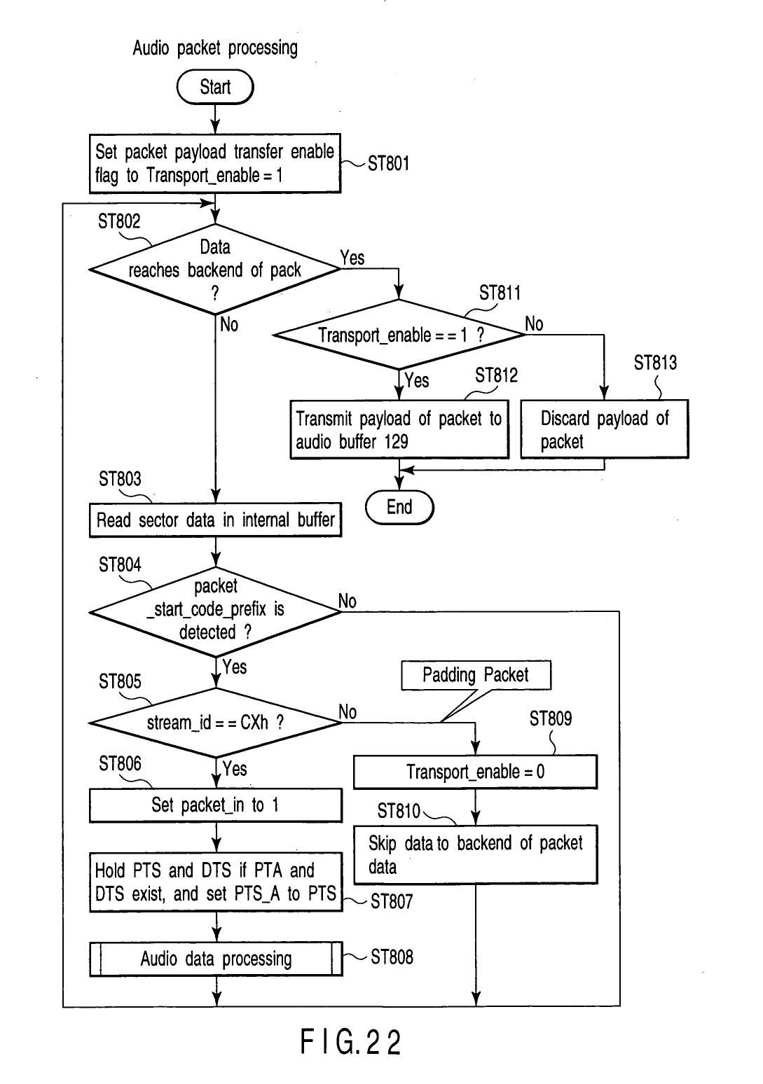

FIG. 22 is a flowchart showing the audio packet processing. The audio packet processing is similar to the video packet processing of FIG. 12.

The stream separation unit 107 sets the packet payload transfer enable flag F5 to 1 (Step ST801). The stream separation unit 107 determines whether or not the position of the data reaches the backend of the pack (Step ST802). When the position of the data does not reach the backend of the pack, the stream separation unit 107 reads predetermined bytes of the contents of the sector data internal buffer 110 (ST803). Then, the stream separation unit 107 determines whether or not packet _start_code_prefix 503 (see FIGS. 7 and 10) is detected (ST804). When packet_start_code_prefix 503 is detected, the stream separation unit 107 determines whether or not stream_id 504 (see FIGS. 7 and 10) is CXh (ST605). The “CXh” is stream_id of the audio which is set in the stream separation unit 107 by the system control unit 200. When the stream_id 504 is CXh, the stream separation unit 107 sets the flag F7 of packet_in to 1 (ST806). When a PTS exists, the stream separation unit 107 holds the PTS, and writes the value of PTS in the register 109a of PTS_A (ST807). Then, the stream separation unit 107 proceeds to an audio data processing (ST808).

When the stream_id is not CXh in Step ST805, the stream separation unit 107 determines that the packet which is currently being read is the padding packet and sets the transfer enable flag F5 to zero (ST809). Therefore, the stream separation unit 107 prohibits the packet data from being transferred to the video buffer 121 and skips the packet data to the backend of the packet data (ST810).

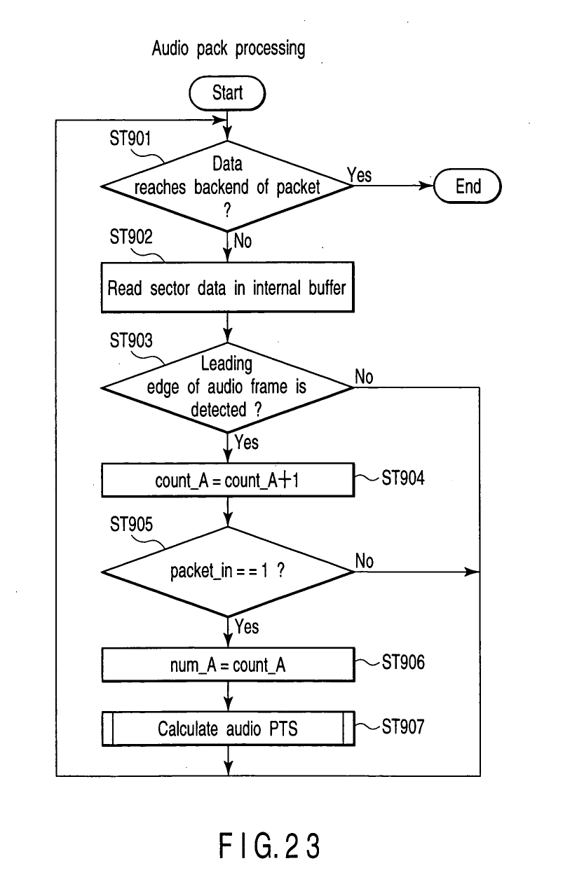

FIG. 23 is a flowchart showing the audio data processing.

The stream separation unit 107 determines whether or not the position of the read data of the sector reaches the backend of the packet (ST901). When the position of the read data of the sector does not reach the backend of the packet, the stream separation unit 107 further reads the contents of the sector data internal buffer 110 (ST902). In Step ST903, the stream separation unit 107 determines whether or not the leading edge of the audio frame is detected. When the leading edge of the audio frame is detected, in Step ST904, the stream separation unit 107 increases the value of the register 109j of count_A by 1. The stream separation unit 107 determines whether or not the flag F7 of packet_in is 1 (ST905). When the flag F7 is 1, the stream separation unit 107 writes the value of the register 109j of count_A in the register 109h of num_A (ST906) to perform audio PTS calculation (ST907).

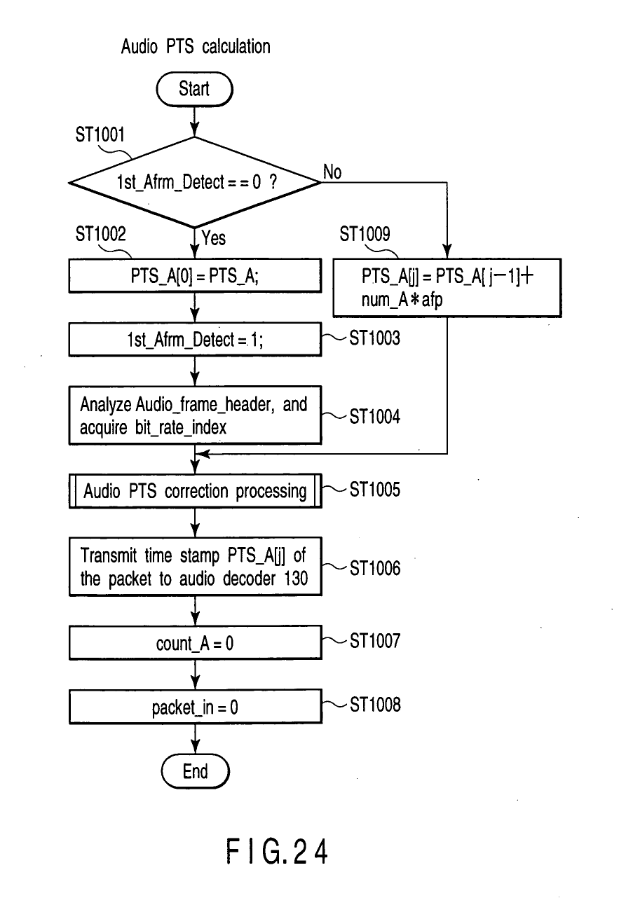

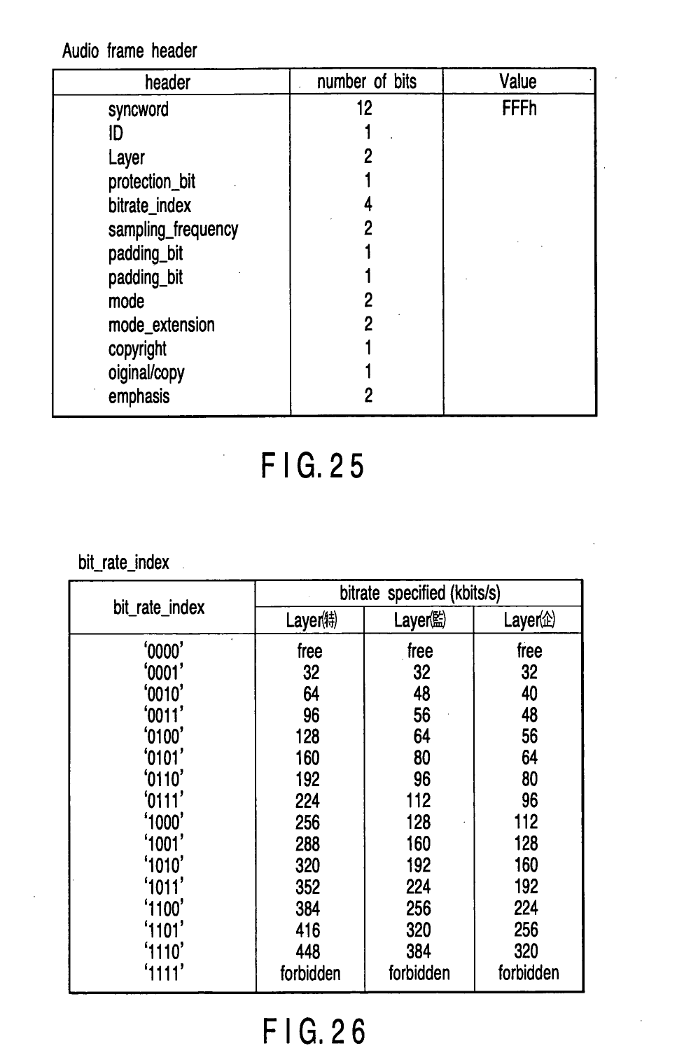

FIG. 24 is a flowchart showing the audio PTS calculation, FIG. 25 shows the flag in the header of the audio frame of the MPEG-1 audio, and FIG. 26 is a table of bit_rate_index of the MPEG-1 audio.

The stream separation unit 107 determines whether or not the flag F4 of1st_Afrm_Detect is zero (ST1001). When the flag F4 is zero (in the case of the first audio frame), the stream separation unit 107 writes the value of the register 109a of PTS_A as the value of the [0]-th PTS_A on the register 109c of PTS_A[i] (ST1002). Then, the stream separation unit 107 sets the flag F4 of 1st_Afrm_Detect to 1 (ST1003), and analyzes Audio_frame_header 507 (see FIG. 7) to acquire bit_rate_index (see FIGS. 25 and 26) (ST1004).

The stream separation unit 107 performs the later-mentioned audio PTS correction processing in Step ST1005 if necessary, and the stream separation unit 107 transmits a time stamp PTS_A[j] (the value of the register 109c) of the packet to the audio decoder 130 (ST1006). As a result, for example, PTS_A (PTS held in ST807) is transmitted as PTS_A[0] of the packet header 402a in the stream of the packet layer of FIG. 2 to the audio decoder 130. The stream separation unit 107 resets the value of the register 109j of count_A to zero (ST1007) and resets the flag F7 of packet_in to zero (ST1008).

When the flag F4 is not zero in Step ST1001, the stream separation unit 107 calculates the current PTS_A[j] by adding num_A*afp to the previous PTS value PTS_A[j-1). Thus, the stream separation unit 107 counts the number of audio frames (num_A) included in the audio packet of the MPEG stream and calculates the new audio PTS on the basis of the number of audio frames, PTS initially acquired in Step ST807, and the reproduction time afp of the audio frame.

Then, the audio PTS correction processing in Step ST1005 will be described.

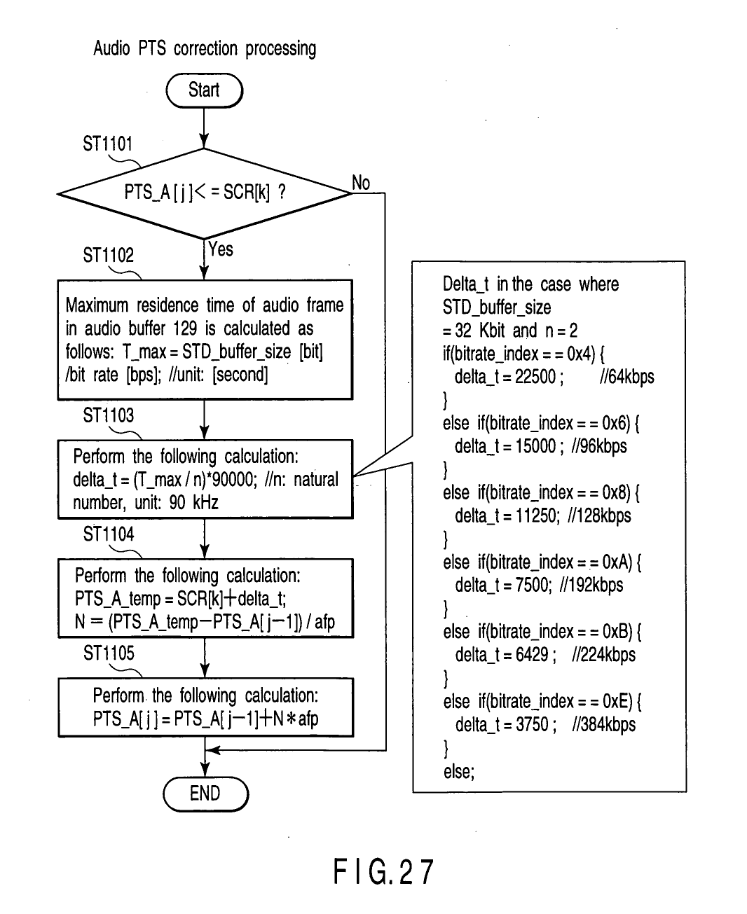

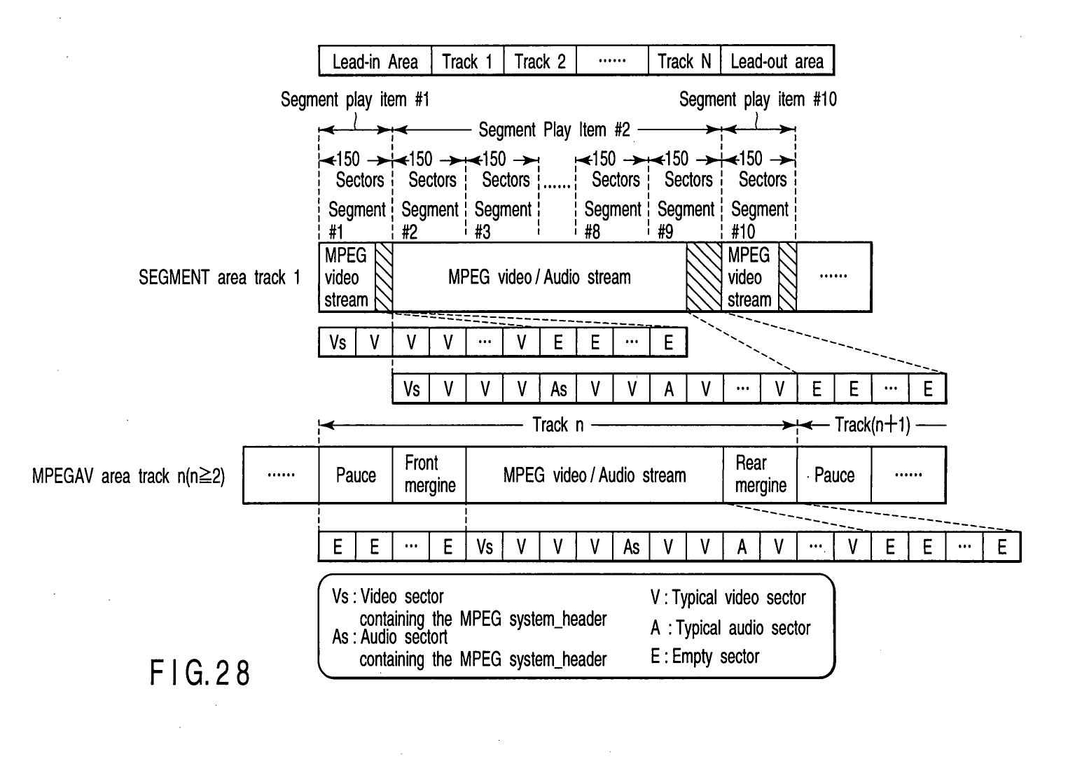

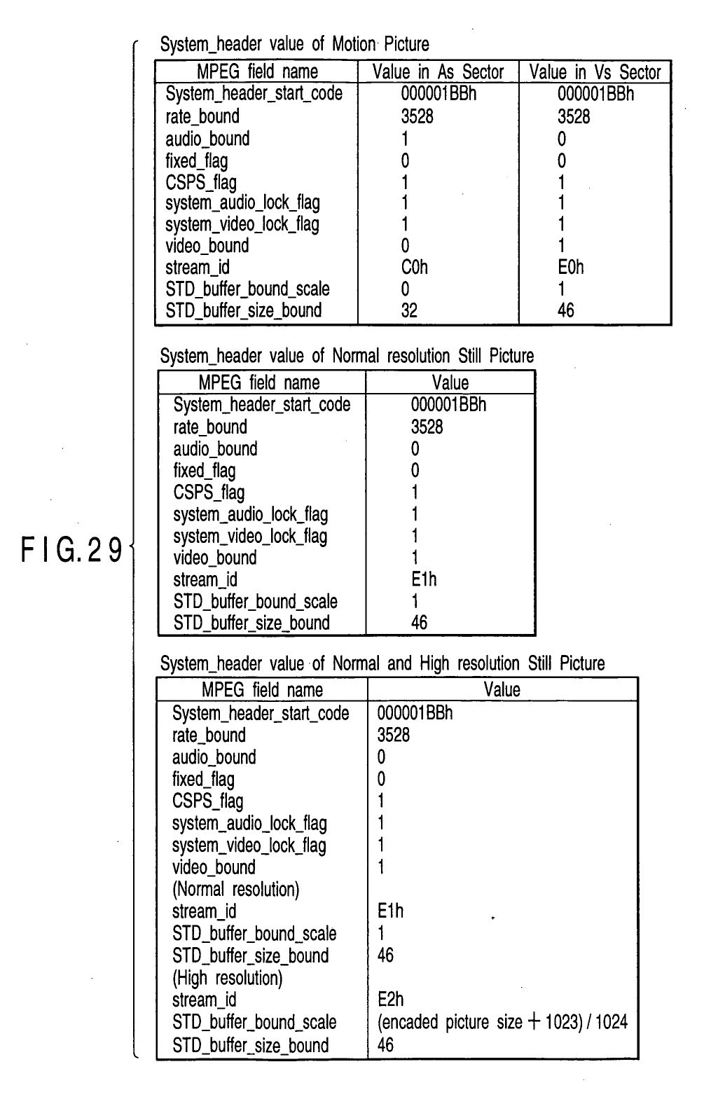

When the audio data is interrupted at some mid-point of the stream in the calculation of the audio PTS according to the above-described processing flow, it is assumed that the relationship PTS (=PTS_A[j]) for the audio packet and SCR (SCR[k]) for the pack including this audio packet becomes PTS_A[j]<=SCR[k]. This is clear infringement, because the audio data included in the pack is decoded before the pack reaches the audio buffer 129. When this time relationship is generated, the stream separation unit 107 performs the audio PTS correction processing. FIG. 27 is a flowchart showing the audio PTS correction processing, FIG. 28 shows a track structure of the video CD, and FIG. 29 shows the contents of the system header of the video CD.

The maximum staying time when the audio frame stays in the audio buffer 129 can be calculated from the STD buffer sizes (STD_buffer_bound_scale and STD_buffer_size_bound) (see FIG. 29) described in the system headers of sectors Vs and As (see FIG. 28) of the MPEG stream and a bit rate described in the audio elementary stream. For example, the audio buffer size is defined in 32 kbit (4 kByte) in the video CD (the actual size of the audio buffer 129 is designed to be 32 Kbit or more), and the MPEG-1 audio (layer II) data is described in the bit rate of 224 kbps in the MPEG AV area of the track 2 or subsequent track 2 (see FIGS. 25 and 26). Therefore, the maximum staying time T_max of the audio frame in the audio buffer 129 becomes T_max=32/224=1/7=about 0.14 sec.

When the time relationship of PTS_A[j]<=SCR[k] is generated (YES in ST1101), the staying time delta_t of the audio frame to which PTS_A[j] is added in the audio buffer 129 becomes delta_t=(T_max/n)×90000 (n is a natural number) in terms of unit of 90 kHz (=1/90000 sec), i.e. a time unit of PTS. When n=2 is substituted, detla_t becomes the average staying time.

At this point, PTS corresponding to the audio frame is calculated about PTS_A_temp =SCR[k]+delta_t. In order to set the difference between the previous PTS_A[j-1] and PTS_A[j] to a multiple, N=(PTS_A_temp−PTS_A[j-1])/audio_frame_period is calculated, and PTS of the audio frame after the correction is calculated PTS_A[j] =PTS_A[j-1]+N*audio_frame_period.

As described above, when the PTS of the packet is not more than SCR calculated in Step ST709 (YES in ST1101), the stream separation unit 107 calculates the maximum delay time T_max by the audio decoder 130 from the audio buffer size and the audio bit rate which are previously obtained (ST1102). Further, the stream separation unit 107 updates the PTS of the audio packet on the basis of the calculated SCR, the maximum delay time T_max calculated in Step ST1102, and the reproduction time afp of the audio frame.

In accordance with the invention, even if the audio data is interrupted at some mid-point of the stream, the audio data and the video data can synchronously be reproduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A video and audio reproduction apparatus for reproducing an MPEG stream including each of video and audio elementary streams recorded in a medium, the apparatus comprising:
a read unit which reads the MPEG stream from the medium;
a first acquisition unit which acquires a video PTS (Presentation Time Stamp) from the MPEG stream read by the read unit;
a first calculation unit which calculates a new video PTS on the basis of the PTS acquired by the first acquisition unit in each time when a picture header is detected from the read MPEG stream;
a second acquisition unit which acquires an audio PTS from the read MPEG stream;
a second calculation unit which counts the number of audio frames included in an audio packet of the read MPEG stream and calculates a new audio PTS on the basis of the PTS acquired by the second acquisition unit and a reproduction time of the audio frame;
a video decoder which decodes video data of the read MPEG stream to provide a video signal in accordance with the PTS calculated by the first calculation unit; and
an audio decoder which decodes audio data of the MPEG stream read by the second calculation unit to provide an audio signal in accordance with the PTS calculated by the second calculation unit.

2. A video and audio reproduction apparatus according to claim 1, wherein the first acquisition unit acquires the initially detected video PTS from the MPEG stream read by the read unit, and the second acquisition unit acquires the initially detected audio PTS from the read MPEG stream.

3. A video and audio reproduction apparatus according to claim 1, wherein the first calculation unit calculates the video PTS on the basis of the PTS acquired by the first acquisition unit and a picture coding type (picture_coding_type) and a temporal reference (temporal_reference) which are described in the picture header.

4. A video and audio reproduction apparatus according to claim 2, wherein the first calculation unit calculates the video PTS on the basis of the PTS acquired by the first acquisition unit and a picture coding type (picture_coding_type) and a temporal reference (temporal_reference) which are described in the picture header.

5. A video and audio reproduction apparatus according to claim 1, further comprising:
a third calculation unit which detects an audio pack SCR (System Clock Reference) from the MPEG stream read by the read unit and calculates a current SCR in each detection of the audio pack by adding a predetermined amount of offset to the previous SCR;
a determination unit which determines whether or not PTS of a packet included in the audio pack is not more than the detected SCR;
a fourth calculation unit which, when the PTS of the packet is not more than the calculated SCR, calculates a maximum delay time by the audio decoder from an audio buffer size and an audio bit rate which are previously acquired; and
an update unit which updates the PTS of the audio packet on the basis of the calculated SCR, the maximum delay time calculated by the fourth calculation unit, and the reproduction time of the audio frame.

6. A Method for reproducing an MPEG stream including each of video and audio elementary streams recorded in a medium, the method comprising:
reading the MPEG stream from the medium;
acquiring a video PTS (Presentation Time Stamp) from the read MPEG stream;
calculating a new video PTS on the basis of the acquired video PTS in each time when a picture header is detected from the read MPEG stream;
acquiring an audio PTS from the read MPEG stream;
counting the number of audio frames included in an audio packet of the read MPEG stream and calculating a new audio PTS on the basis of the acquired audio PTS and a reproduction time of the audio frame;
decoding video data of the read MPEG stream to provide a video signal in accordance with the calculated video PTS; and
decoding audio data of the read MPEG stream to provide an audio signal in accordance with the calculated audio PTS.

7. A Method according to claim 6, wherein in the step of calculating the video PTS, the video PTS is calculated on the basis of the acquired video PTS, and a picture coding type (picture_coding_type) and a temporal reference (temporal_reference) which are described in the picture header.
